(19) United States
(12) Patent Application Publication
(10) Pub. No.: US 2025/0175817 A1
(43) Pub. Date: May 29, 2025

(54) MULTICAST BROADCAST MODE SWITCHING

(71) Applicant: QUALCOMM Incorporated, San Diego, CA (US)

(72) Inventors: Haris ZISIMOPOULOS, London (GB); Miguel GRIOT, La Jolla, CA (US); Le LIU, San Jose, CA (US); Prasada Reddy KADIRI, San Diego, CA (US); Umesh PHUYAL, San Diego, CA (US)

(21) Appl. No.: 18/842,776

(22) PCT Filed: Mar. 13, 2023
(86) PCT No.: PCT/US2023/015138

§ 371 Date: Aug. 29, 2024

(30) Foreign Application Priority Data
May 6, 2022 (GR) 20220100377

(51) Int. Cl. H04W 24/02; H04W 72/12; H04W 76/20; H04W 76/40

(52) U.S. Cl. CPC H04W 24/02; H04W 72/12; H04W 76/20; H04W 76/40

(57) ABSTRACT

Apparatus, methods, and computer program products for multicast broadcast service (MBS) are provided. An example method may include a configuration of multicast service information and broadcast service information, the multicast service information being for a multicast session for an MBS scheduled to transmit content to the UE, the broadcast service information being for a broadcast session for the MBS scheduled to transmit the content to the UE. The example method may further include receiving, from a network node, an indication that indicates a suspension of one of the multicast session or the broadcast session for the MBS. The example method may further include obtaining the content via a unicast session or a non-suspended session in response to the indication, the non-suspended session being the other of the multicast session or the broadcast session.

### CROSS-REFERENCE TO RELATED APPLICATION(S)

This application claims the benefit of and priority to Greek patent application Ser. No. 20220100377, entitled “MULTICAST BROADCAST MODE SWITCHING” and filed on May 6, 2022, which is expressly incorporated by reference herein in its entirety.

### TECHNICAL FIELD

The present disclosure relates generally to communication systems, and more particularly, to wireless communication including a multicast broadcast service.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may be configured to receive a configuration of multicast service information and broadcast service information, the multicast service information being for a multicast session for a multicast broadcast service (MBS) scheduled to transmit content to the UE, the broadcast service information being for a broadcast session for the MBS scheduled to transmit the content to the UE. The apparatus may be further configured to receive, from a network node, an indication that indicates a suspension of one of the multicast session or the broadcast session for the MBS. The apparatus may be further configured to obtain the content via a unicast session or a non-suspended session in response to the indication, the non-suspended session being the other of the multicast session or the broadcast session.

In another aspect of the disclosure, a method, a computer-readable medium, and an apparatus at a network node are provided. The apparatus may include a memory and at least one processor coupled to the memory. The apparatus may be configured to suspend one of a multicast session for a multicast broadcast service (MBS) or a broadcast session for the MBS based on a number of user equipment receiving content of the MBS relative to a threshold number. The apparatus may be further configured to output for transmission an indication that indicates a suspension of the one of the multicast session or the broadcast session for the content of the MBS.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network, in accordance with various aspects of the present disclosure.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network, in accordance with various aspects of the present disclosure.

FIG. 4A is a diagram illustrating an example of Multicast Broadcast Service (MBS) areas in an access network.

FIG. 4B is a diagram illustrating an example of an MBS channel configuration.

FIG. 5A and FIG. 5B show diagrams and illustrating service areas and for MBSs that are transmitted at least by a transmit receive point (TRP) or base station.

FIG. 6 is a diagram showing a service area for a multicast service for an MBS that overlaps with a service area for a broadcast service for the MBS.

FIG. 7 is a diagram illustrating example MBS session.

FIG. 8A is a diagram illustrating an example communication flow for a UE and a RAN that includes RAN based switching from a multicast reception to broadcast reception of an MBS.

FIG. 8B is a diagram illustrating an example communication flow for a UE and a RAN that includes RAN based switching from a broadcast reception to multicast reception of an MBS.

FIG. 9A is a diagram illustrating an example communication flow for a UE and a RAN that includes RAN based switching to unicast reception of an MBS.

FIG. 9B is a diagram illustrating an example communication flow for a UE and a RAN that includes RAN based switching to unicast reception of an MBS.

FIG. 10A is a flowchart of a method of wireless communication.

FIG. 10B is a flowchart of a method of wireless communication.

FIG. 11 is a diagram illustrating an example of a hardware implementation for an example apparatus and/or UE.

FIG. 12A is a flowchart of a method of wireless communication.

FIG. 12B is a flowchart of a method of wireless communication.

FIG. 13 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

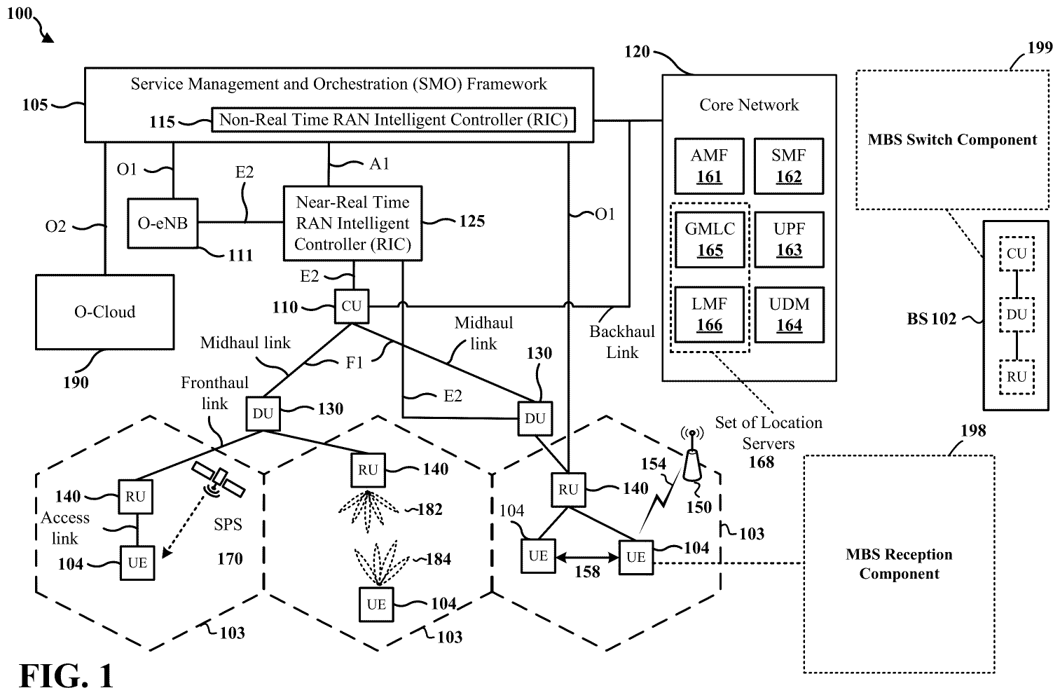

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 within a coverage area of a cell 103 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include an MBS switch component 198. In some aspects, the MBS switch component 198 may be configured to receive a configuration of multicast service information and broadcast service information, the multicast service information being for a multicast session for a multicast broadcast service (MBS) scheduled to transmit content to the UE, the broadcast service information being for a broadcast session for the MBS scheduled to transmit the content to the UE. In some aspects, the MBS switch component 198 may be further configured to receive, from a network node, an indication that indicates a suspension of one of the multicast session or the broadcast session for the MBS. In some aspects, the MBS switch component 198 may be further configured to obtain the content via a unicast session or a non-suspended session in response to the indication, the non-suspended session being the other of the multicast session or the broadcast session.

In certain aspects, the base station 102 may include an MBS reception component 199. In some aspects, the MBS reception component 199 may be configured to suspend one of a multicast session for a multicast broadcast service (MBS) or a broadcast session for the MBS based on a number of user equipment receiving content of the MBS relative to a threshold number. In some aspects, the MBS reception component 199 may be further configured to output for transmission an indication that indicates a suspension of the one of the multicast session or the broadcast session for the content of the MBS.

Although the following description may be focused on 5G NR, the concepts described herein may be applicable to other similar areas, such as LTE, LTE-A, CDMA, GSM, and other wireless technologies.

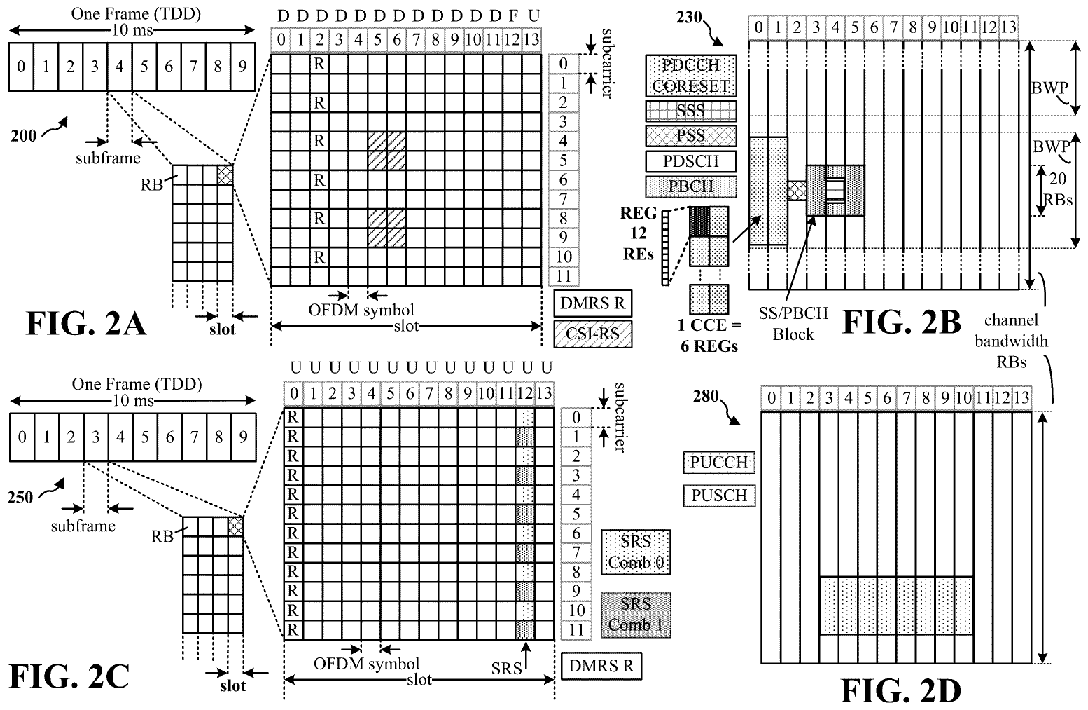

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | Cyclic |
|---|---|---|
| μ | Δf = 2μ · 15 [kHz] | prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

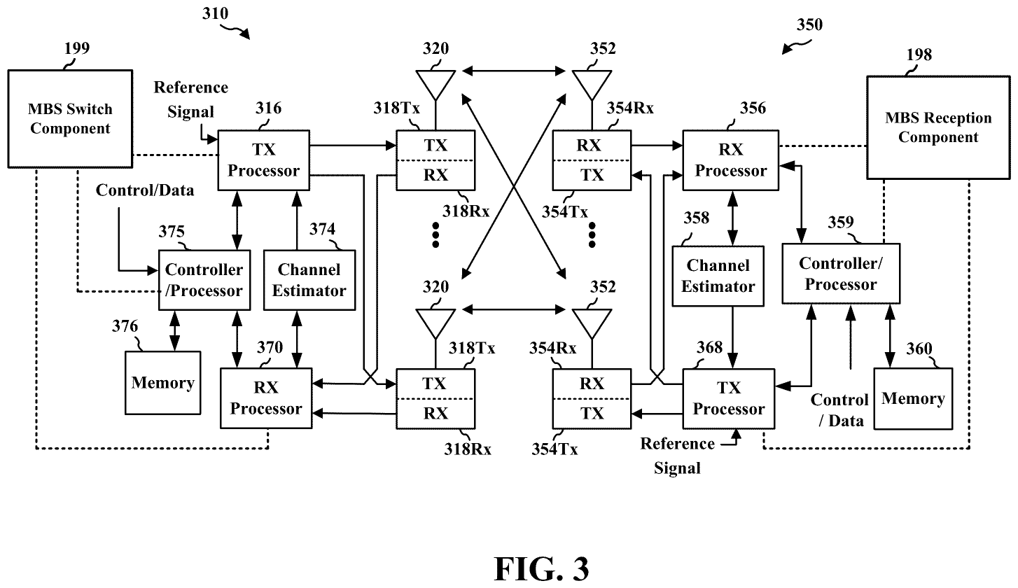

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the MBS reception component 198 of FIG. 1.

At least one of the TX processor 316, the RX processor 370, and the controller/processor 375 may be configured to perform aspects in connection with the MBS switch component 199 of FIG. 1.

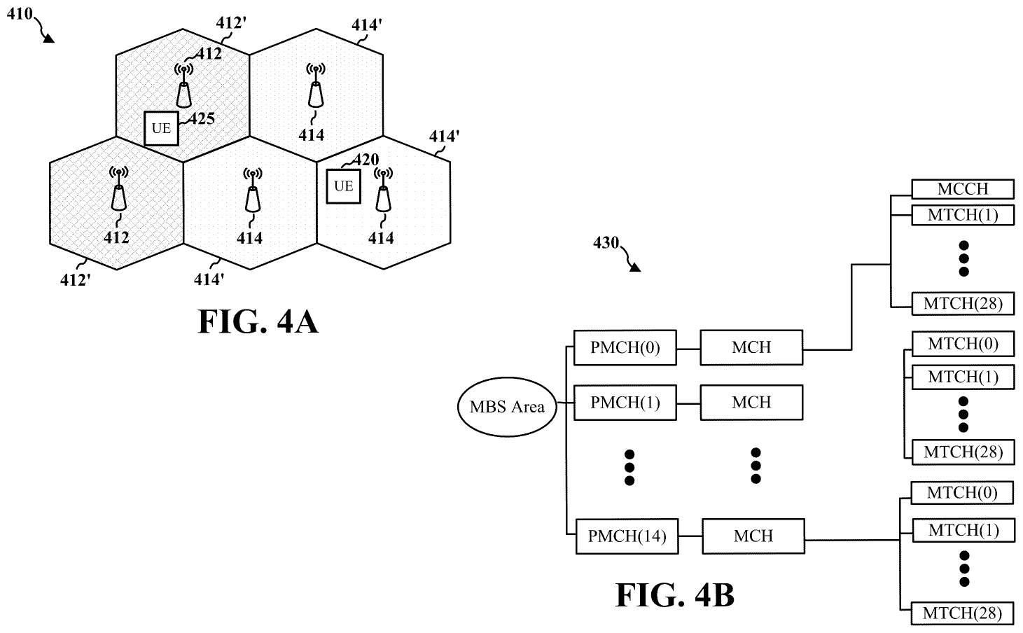

FIG. 4A is a diagram 410 illustrating an example of MBS areas in an access network. The base station 412 (or TRP) in cells 412′ may form a first MBS area and the base stations 414 in cells 414′ may form a second MBS area. The base stations 412, 414 may each be associated with other MBS areas. A cell within an MBS area may be designated a reserved cell. Reserved cells may not provide multicast/broadcast content, but may be time-synchronized to the cells 412′, 414′ and may have restricted power on MBS resources in order to limit interference to the MBS areas. Each base station in an MBS area synchronously transmits the same MBS control information and data. Each area may support broadcast, multicast, and unicast services. A unicast service is a service intended for a specific user, e.g., a voice call to a particular UE. A multicast service is a service that may be received by a group of users and may also be referred to as a groupcast, e.g., a subscription video service. A broadcast service is a service that may be received by any user within the coverage area, e.g., a news broadcast. Referring to FIG. 4A, the first MBS area may support a first MBS broadcast service, such as by providing a particular news broadcast to UE 425. The second MBS area may support a second MBS broadcast service, such as by providing a different news broadcast to UE 420.

FIG. 4B is a diagram 430 illustrating an example of an MBS channel configuration in an MBS. As shown in FIG. 4B, each MBS area supports one or more physical multicast channels (PMCH) (e.g., 15 PMCHs). Each PMCH corresponds to an MCH. Each MCH can multiplex a plurality (e.g., 29) of multicast logical channels. Each MBS area may have one multicast control channel (MCCH). As such, one MCH may multiplex one MCCH and a plurality of multicast traffic channels (MTCHs) and the remaining MCHs may multiplex a plurality of MTCHs.

A UE can camp on a cell to discover the availability of MBS service access and a corresponding access stratum configuration. Initially, the UE may acquire a SIB that includes information that enables the UE to acquire an MBS area configuration message on an MCCH. Subsequently, based on the MBS area configuration message, the UE may acquire a multicast channel (MCH) Scheduling Information (MSI) medium access control-control element. The SIB may include an MBS area identifier of each MBS area supported by the cell and information for acquiring the MCCH. There may be one MBS area configuration message for each MBS area. The MBS area configuration message may indicate a temporary mobile group identity (TMGI) and an optional session identifier of each MTCH identified by a logical channel identifier within the PMCH and allocated resources in time and/or frequency for each PMCH of the MBS area. A particular TMGI identifies a particular service of available MBS services.

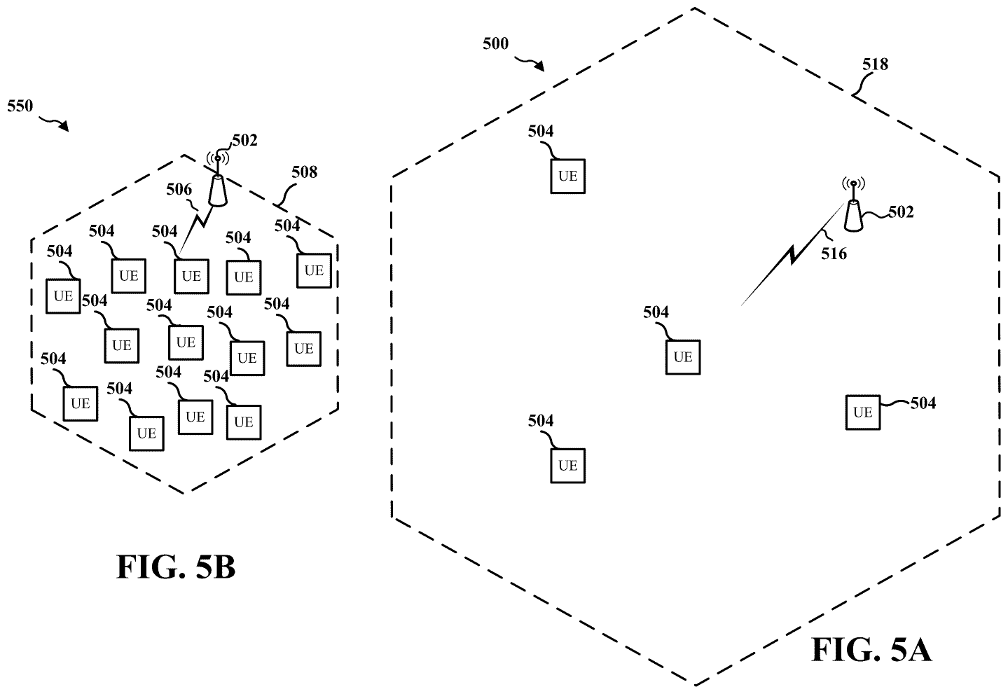

Some broadcast and multicast services may be configured for different scenarios and may be optimal under different scenarios. As an example, in a setting with sparser UEs receiving the same MBS content, the service area may be configured to be larger than for a setting in which the UEs receiving the MBS content are concentrated in a denser arrangement. A multicast may be beneficial to provide the MBS content to the more sparsely located UEs within the larger service area. FIG. 5A and FIG. 5B show diagrams 500 and 550 illustrating service areas 508 and 518 for MBSs that are transmitted at least by the TRP or base station 502. The coverage area 518 of the MBS in FIG. 5A is larger than the service area 508 in FIG. 5B, and the UEs 504 that are receiving the MBS content in the multicast signal 516 are more sparsely located within the service area 518 than the UEs 504 within the service area 508. In the sparser setting in FIG. 5A, the MBS may be transmitted via multicast, which may provide a higher quality signal to the UEs. In FIG. 5B, the UEs 504 receiving the same MBS content are more concentrated within the service area 508, and the MBS may be broadcast to the UEs 504. Resources may be configured in a service area without consideration for potential locations of UEs receiving the broadcast service. A downlink transmission may not be tailored to the situation of UEs camping on a specific cell. A broadcast session may allow for UEs receiving broadcast service, e.g., from an idle state such as a connection management (CM)-IDLE state, without performing a UE join procedure, i.e., without control plane signalling. Thus, in some aspects, the broadcast may be beneficial in serving a large amount of UEs in a relatively small area.

As an example, areas having more concentrated numbers of UEs, or more densely located UEs, may be provided with a broadcast session for an MBS, e.g., broadcast may be an optimal type of transport for the MBS. In areas with fewer, or sparser, UEs, an MBS providing the same MBS content may be multicast rather than broadcast. As one, non-limiting example of MBS content, the UEs in FIGS. 5A and 5B may receive the same public safety service, which may be broadcast in the service area 508 and multicast in the service area 518. In some aspects, the network may configure a broadcast service for the MBS content and a multicast service for the MBS content. FIG. 5A shows that the MBS content may be transmitted both in a multicast signal 516 for a multicast session for the MBS and in a broadcast signal 506 in a broadcast session for the MBS. The individual UEs may select between reception of the MBS content via the broadcast service and, if available, reception of the MBS content via the multicast session.

The network may identify areas of concentrated numbers of UEs, e.g., for which the broadcast services may provide benefits over the multicast service or vice versa. In order to identify the UE concentration, UEs may provide accurate location information to a group communication service application server (GCS AS) to enable the GCS AS to determine where UEs are concentrated. The location information may include a cell ID and/or MBS service area in which the UE is located. FIG. 1 illustrates various UEs 104 located within coverage areas of different cells 103, and FIGS. 5A and 5B illustrate UEs located within different MBS service areas. FIG. 4A illustrates an example in which multiple cells, e.g., 412′ may be comprised in a single MBS service area.

A GCS AS (or a mission critical service (MCX) AS) may activate an MBS broadcast session in broadcast service areas where MBS capable UEs are or are expected to be located. For that, the GCS AS (or MCX AS) may use the MBS service area identifier (SAI) and/or cell identifier (ID) information to construct the MBS broadcast area parameter. The location management server (LMS) may configure a location management client (LMC) with the parameters to report and determine the granularity and frequency of location reports from the UEs.

To activate the multicast media bearers the multicast service server (MC service server) may use an activate MBS bearer procedure with the MC service server performing the GCS AS function. The MC service server may activate MBS bearers in broadcast areas where MBS capable UEs are located or are expected to be located. The MC service server may use the MBS SAI and/or cell ID information to construct the MBS broadcast area parameter in the activate MBS bearer procedure.

To deactivate the multicast media bearers the MC service server may use a deactivate MBS bearer procedure with the MC service server performing the GCS AS function. To modify multicast media bearers, the MC service server may use the Modify MBS bearer procedure with the MC service server performing the GCS AS function.

The application server (AS) may provide a request to a core network to establish a broadcast service in a broadcast service area via an MBS session start for broadcast procedure, for a broadcast service area that corresponds to an identified area including a concentrated, e.g., large number, amount of UEs. FIG. 5B is an example of a broadcast service area, e.g., service area 508, having a concentration of UEs that may trigger a request to establish a broadcast service.

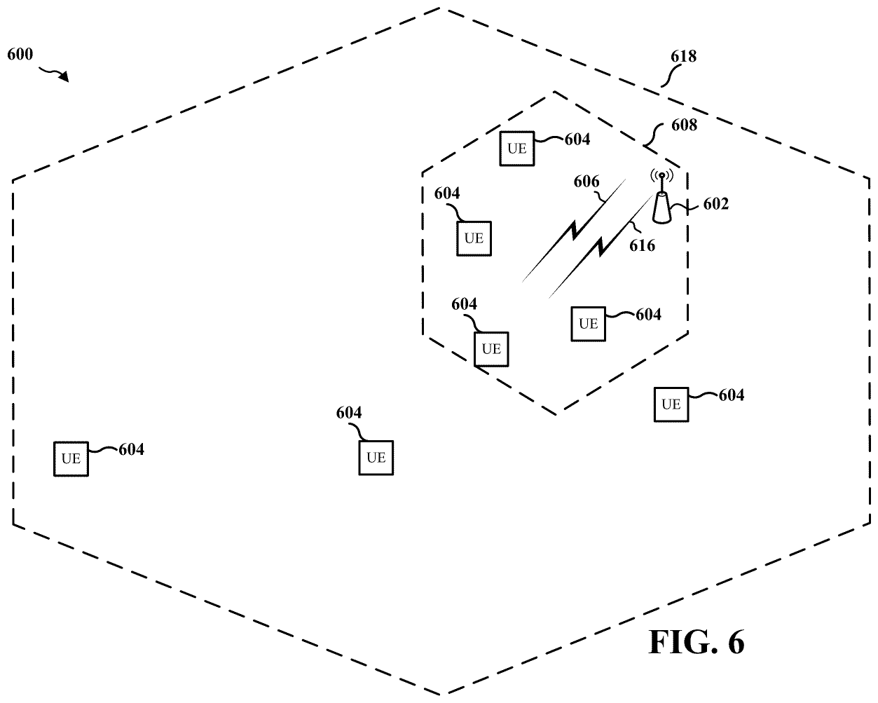

The same AS may also request to establish a multicast service in a multicast service area via an MBS session creation procedure, where the multicast service area corresponds to an identified area for the service and that may be larger than the broadcast service area. The multicast and broadcast service areas may overlap. FIG. 6 is a diagram 600 showing a service area 618 for a multicast service for an MBS that overlaps with a service area 608 for a broadcast service for the MBS. The TRP or base station 602 transmits a multicast signal 616 to the UEs 104 with the MBS content and broadcasts a broadcast signal 606 to the UEs 604 with the same MBS content.

The AS may configure a UE 104 with both the multicast service information (e.g., with the respective MBS session ID/TMGI for the multicast service) and the broadcast service information (e.g., with the respective MBS Session ID/TMGI for the broadcast service) and may indicate to the UE that the multicast service and the broadcast service correspond to the same MBS service. As an example, the multicast service and the broadcast service may correspond to a same public safety service, among other possible examples. In some aspects, the AS may include both TMGIs (e.g., a first TMGI for the broadcast service and a second TMGI for the corresponding multicast service) in a service description that is sent to the UE in a session initiated protocol (SIP) message using an announcement parameter, e.g., rather than sending the service description individually for a single TMGI.

In some aspects, both the broadcast service area, e.g., 608, and the multicast service area, e.g., 618, may be known to a UE 604. As an example, the UE 604 may receive information indicating the broadcast service area, e.g., 608, in a service announcement and may receive information about the multicast service area, e.g., 618, in a service announcement or in non-access stratum (NAS) signaling. A UE 604 may join the multicast session, e.g., and may receive the MBS content via the multicast signal 616, based on the received information from the AS. If the UE is outside the broadcast service area 608, and in multicast service area 618, the UE 604 may receive the MBS service in a multicast mode, e.g., via the multicast signal 616. If not already joined, the UE 604 may initiate a procedure for the UE join the multicast session in order to receive the MBS content.

FIG. 6 illustrates an example procedure for an AS to provide a same MBS via a broadcast session in a first service area (e.g., a broadcast service area such as 608) and via a multicast session in a second service area (e.g., a multicast service area such as 618) that is larger than the first service area.

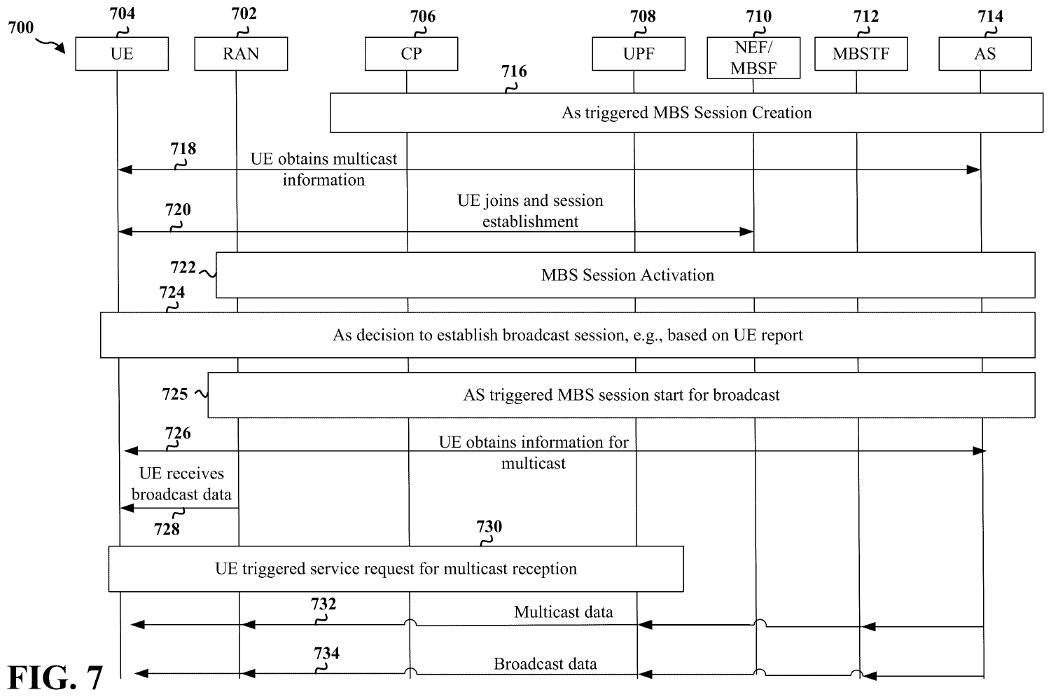

FIG. 7 is a diagram 700 illustrating example MBS session. As illustrated in FIG. 7, in order to establish a multicast session, the AS 714 may initiate MBS session creation at 716 which may be with policy and charging control (PCC) or without PCC. The AS 714 may receive multicast session information. As an example, at 716, the AS 714 may send a request with a TMGI number to a network exposure function (NEF)/multicast/broadcast service function (MBSF) (NEF/MBSF) 710 to request allocation of a TMGI(s) to identify new MBS session(s). The NEF/MBSF 71 may check authorization of the AS 714, communicate with a multicast/broadcast session management function (MBSMF) to get allocated TMGI and expiration, then send a response to the AS 814. The AS 714, the UPF 708, the control plane (CP) 706, the MBSTF 712, and the NEF/MBSF 710 may communication with each other for the MBS session creation.

At 718. the AS may provide to UE(s) including the UE 704 with the multicast session information for the UE 704 to join the multicast session (i.e. the TMGI for multicast session). In some aspects, AF 718 may be associated with a content provider and may provide description for an MBS session (possibly providing information for a previously allocated TMGI to NEF MBS session request that may include MBS session ID, service type, MBS information, TMGI allocation indication, or the like. In some aspects, at 720, the UE 704 may join the MBS session and participate in a session establishment procedure using the TMGI. In some aspects, the UE 704 may also be associated with MBS subscription data.

In some aspects, at 722, the AS 718 may initiate MBS session activation for multicast TMGI when there is MBS data. For example, the AS 718 may request the MBSMF to activate the MBS session to the MBSMF directly or via the NEF.

In some aspects, at 724, the AS 718 may decide to establish a Broadcast session in a specific service area, e.g. based on UE reports in GCI interface or over a mission critical push to talk-1 (MCPTT-1) interface and detection of large number of UE receiving the same service in a same area. Based on the decision at 724, the AS 718 may initiate MBS session start for broadcast procedure for a broadcast TMGI at 725. The AS 714 may provide to UEs including the UE 704 with the information for broadcast reception, including the TMGI allocated for the broadcast session at 726. In some aspects, at 728, the UE 704 may receive both the broadcast session information (including TMGI for broadcast session) and multicast session information (including TMGI for Multicast session) for the same service/content, and may determine whether to receive the MBS service via broadcast session or multicast session. In some aspects, at 730, if the UE 704 detects that the broadcast session is available, the UE 704 may enable reception of broadcast data 732 for the TMGI allocated for the broadcast session. If the UE 704 already joined the multicast session, the UE 704 may ignore reception of multicast data 732. The UE may ignore a paging with the TMGI allocated for the multicast session. In some aspects, if the UE 704 failed to detect that broadcast session is available, and the UE 704 joined the multicast MBS session when it receives paging during MBS session activation for the TMGI allocated for multicast, the UE 704 may receive the multicast data 732. The UE 704 may detect the broadcast later and deactivate the multicast accordingly.

As illustrated in FIG. 7, the RAN 702 transmits the same content over multicast and broadcast. The same MBS content is represented by two different MBS sessions, having separate session IDs and/or TMGIs. The dual transmission uses additional radio resources at the RAN.

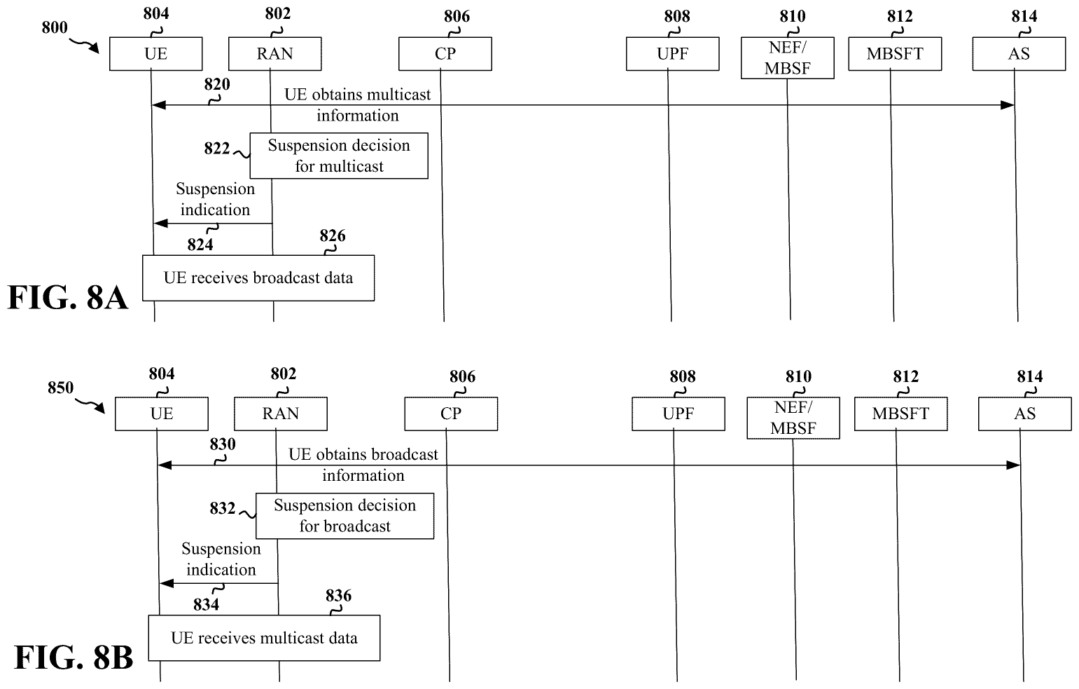

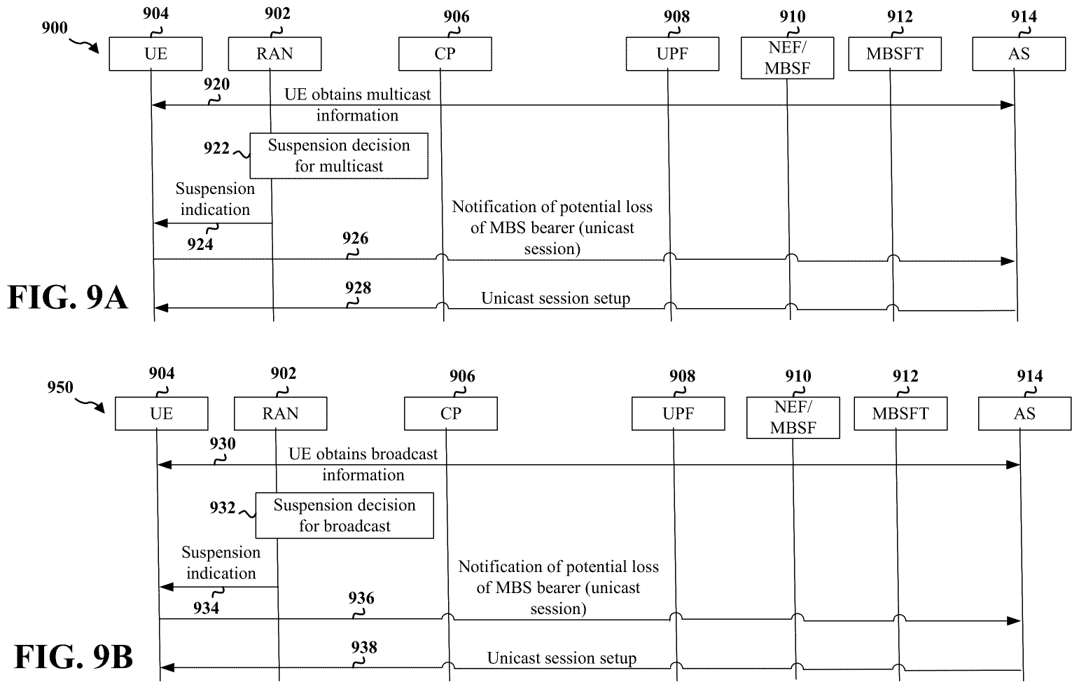

Aspects presented herein provide a switching mechanism that allows the RAN to switch between different transmission modes for an MBS in order to use radio resources more efficiently. For example, the RAN may determine to suspend, or stop, either the multicast, e.g., 732 or 616, or the broadcast, e.g., 734 or 606. Aspects presented herein provide for signaling that enables the UEs receiving the MBS to switch to the other MBS reception mode in response to the RAN suspending the multicast and/or broadcast. FIGS. 8A, 8B, 9A and 9B illustrate various examples of switching between cast types for an MBS.

In some aspects, a UE based approach may be allowed or enabled, and a UE 604 may switch between a broadcast session and a multicast session for the same MBS. As an example, when the UE is in a broadcast service area (e.g., 608), and the UE detects the broadcast service is available, the UE may enable reception of the broadcast MBS session ID (e.g., 606), and if already joined, the UE 604 may ignore reception of the multicast MBS session ID, e.g. the multicast signal 616, such as described in connection with FIG. 7. In a network based approach, such as a RAN based approach, for the switching is used, a procedure such as described in connection with any of FIGS. 8A-9B may be used. If the UE is outside the broadcast service area (e.g., 608), and inside the multicast service area, e.g., 618, the UE 604 may receive the MBS service in a multicast mode, e.g., via 616. If not already joined, the UE may initiate a procedure for the UE to join the multicast session.

The UE based option for switching, e.g., as described in connection with FIG. 6 and FIG. 7, from multicast reception to broadcast reception involves the same MBS content being provided in the same cell using both multicast and broadcast delivery modes. If there is congestion in a multicast session, the related multicast radio bearer (MRB) may be suspended by the RAN 802 and the UE 804 may become aware of the suspension in any of various ways. As an example, the UE can detect that MBS multicast delivery is no longer available when the related TMGI is removed from a MCCH that is received by the UE. The UE 804 may receive an explicit indication broadcast from the RAN 802 informing the UE that transmission for the multicast MBS bearer is going to be, or has been, suspended. FIG. 8A illustrates an example communication flow 800 for a UE 804 and a RAN 802 that includes RAN based switching from a multicast reception to broadcast reception of an MBS.

FIG. 8A illustrates that the UE 804 has an ongoing group communication using MBS multicast mode. The UE 804 may obtain the multicast information, at 820 from the AS 814. The UE 804 and the AS 814 may interact, such as described in connection with FIG. 7, for the UE to obtain the multicast information and begin to receive the multicast session of the MBS. The AS 814, the UPF 808, the control plane (CP) 806, the MBSTF 812, and the NEF/MBSF 810 may communicate with each other for the MBS session creation.

At 822, the RAN 802 may decide to suspend one or more MBS bearer(s). As an example, the RAN 802 may decide to suspend the MBS bearer(s) after, or in response to, detecting MBS congestion. In some aspects, the RAN 802 may determine to suspend the MBS bearer(s) in response to an occurrence of a triggering condition. The triggering condition may be based on the number of UEs, congestion in the resources of the RAN, etc. For example, if the number of UEs or concentration of UEs in a particular area exceeds a threshold amount, or location of the UEs is within an area of a threshold size, it may be better for the RAN to suspend the multicast and instead broadcast the MBS, such as shown in FIG. 5A. In some aspects, the decision, at 822, may be based on an allocation and retention policy (ARP) and/or on counting results for the corresponding MBS service(s)). The RAN may trigger the migration of impacted UEs to receive the downlink data in MBS broadcast mode. As illustrated at 824, the RAN 802 may provide a suspension indication 824 to the impacted UEs, e.g., 804. As part of providing the suspension indication 824, in some aspects, the RAN 802 may explicitly inform those UEs that the MBS bearer has been, or is going to be, suspended by broadcasting an indication and removing the TMGI for the corresponding multicast session for the MBS from the MCCH. The indication may be broadcast within a cell or broadcast area. The indication may be multicast in the cell or service area. The indication 824 may indicate to the UE 804 that an MTCH for the multicast session is going to be, or has been, suspended. In some aspects, the indication 824 may indicate to the UE to switch to a different cast type of the same MBS service. As an example, the indication 824 may indicate to the UE 804 to switch to a broadcast session of the same MBS. In an example, shown in diagram 900 of FIG. 9A, a similar indication may indicate to the UE to switch to reception of the MBS via unicast. In some aspects, the suspension indication 824 may be included in a MAC-CE indicating the multicast MRB suspension. In some aspects, the MAC-CE may be a dedicated MAC-CE for indicating the multicast MRB suspension. In some aspects, the suspension indication 824 may be received in a TMGI based group paging that indicates a suspension of the multicast in common signaling to the group of UEs receiving the multicast. In some aspects, the suspension indication 824 may be included in unicast signaling. As an example, the RAN 802 may remove a group radio network temporary identifier (G-RNTI) or a group configured scheduling radio network temporary identifier (G-CS-RNTI) associated with a particular TMGI for the corresponding multicast session in a unicast transmission to the UE 804. As an example, the unicast transmission may be unicast RRC signaling and/or a unicast MAC-CE to the UE 804. In some aspects, the indication 824 may be an implicit indication. In some aspects, the RAN 802 may remove the TMGI of the MBS bearer that has been suspended from the MCCH, which may indicate to the UE 804 that the multicast session is being suspended. As another example, the RAN 802 may remove the TMGI for the multicast session of the MBS from a SIB in order to indicate to the UEs receiving the multicast MBS that the multicast session has been, or will be suspended.

The RAN 802 may suspend the multicast session for the MBS. In some aspects, the RAN 802 may suspend the multicast session for the MBS after sending the indication 824. In some aspects, the RAN may stop transmission of the content over the multicast session following expiration of a timer after transmission of the indication 824. In some aspects, the RAN 802 may suspend the multicast session of the MBS prior to sending the indication, and the indication may inform the UE 804 of the suspension.

As illustrated at 826, the UE 804 receives the downlink data for the MBS by broadcast delivery and may continue to monitor MBS channels for resumption of the MBS bearer. For example, the UE 804 may associate the MBS session ID/TMGI of the service announcement received from the AS 814 for the broadcast of the corresponding MBS and may then receive the MBS content for the suspended multicast session using a broadcast mode procedure. For example, in FIG. 6, a UE 604 may stop receiving the multicast signal 616 for the MBS and may start receiving the broadcast signal 606 for the same MBS.

In some aspects, the UE 804 may detect the suspension of the corresponding MBS bearer service based on the indication 824, and may continue to monitor for an MBS multicast mode delivery. In some aspects, the UE 804 may notify the GCS AS 814 of the MBS service suspension, e.g., over an GCI interface or over a mission critical push to talk-1 (MCPTT-1) interface. The GCS AS may decide to set up the broadcast delivery path for the downlink data for this service following the procedure described in connection with FIG. 7, for example. In some aspects, the GCS AS may inform the UE for the switch to the broadcast delivery, e.g., broadcast reception of the MBS at 826.

FIG. 8B is a diagram 850 illustrating that the UE 804 has an ongoing group communication using MBS broadcast mode. The UE 804 may obtain the broadcast information, at 830 from the AS 814. The UE 804 and the AS 814 may interact, such as described in connection with FIG. 7, for the UE to obtain the broadcast information and begin to receive the broadcast session of the MBS.

At 832, the RAN 802 may decide to suspend one or more broadcast bearers for the MBS. As an example, the RAN 802 may decide to suspend the broadcast bearers for the MBS bearer in response to an occurrence of a triggering condition. The triggering condition may be based on the number of UEs, congestion in the resources of the RAN, etc. For example, if the number of UEs or concentration of UEs in a particular area falls below a threshold amount, or location of the UEs is within an area that exceeds a threshold size, it may be better for the RAN to suspend the broadcast and instead multicast the MBS, such as shown in FIG. 5B. As an example, the RAN 802 may decide to suspend the broadcast bearers for the MBS after, or in response to, detecting MBS congestion that drops below a threshold congestion level. In some aspects, the decision, at 832, may be based on an allocation and retention policy (ARP) and/or on counting results for the corresponding MBS service(s)). The RAN may trigger the migration of impacted UEs to receive the downlink data in MBS multicast mode. As illustrated at 834, the RAN 802 may provide a suspension indication 834 to the impacted UEs, e.g., 804. As part of providing the suspension indication 834, in some aspects, the RAN 802 may explicitly inform those UEs that the broadcast bearer for the MBS has been, or is going to be, suspended by broadcasting an indication and removing the corresponding TMGI for the broadcast session of the MBS from the MCCH. The indication may be broadcast within a cell or broadcast area. The indication may be multicast in the cell or service area. The indication 834 may indicate to the UE 804 that an MTCH for the broadcast is going to be, or has been, suspended. In some aspects, the indication 834 may indicate to the UE to switch to a different cast type of the same service. As an example, the indication 834 may indicate to the UE 804 to switch to a multicast of the same MBS. In an example, shown in FIG. 9B, a similar indication may indicate to the UE to switch from broadcast reception to reception of the MBS via unicast. In some aspects, the suspension indication 834 may be included in a MAC-CE indicating the broadcast radio bearer suspension. In some aspects, the MAC-CE may be a dedicated MAC-CE for indicating the broadcast suspension. In some aspects, the suspension indication 834 may be received in a TMGI based group paging that indicates a suspension of the broadcast in common signaling to the group of UEs receiving the broadcast. In some aspects, the suspension indication 834 may be included in unicast signaling. As an example, the RAN 802 may remove a group radio network temporary identifier (G-RNTI) or a group configured scheduling radio network temporary identifier (G-CS-RNTI) associated with a particular TMGI in a unicast transmission to the UE 804. As an example, the unicast transmission may be unicast RRC signaling and/or a unicast MAC-CE to the UE 804. In some aspects, the indication 834 may be an implicit indication. In some aspects, the RAN 802 may remove the TMGI of the broadcast MBS bearer that has been suspended from the MCCH, which may indicate to the UE 804 that the broadcast session is being suspended. As another example, the RAN 802 may remove the TMGI for the broadcast session from a SIB in order to indicate to the UEs receiving the broadcast MBS that the broadcast session has been, or will be suspended.

The RAN 802 may suspend the broadcast session for the MBS. In some aspects, the RAN 802 may suspend the broadcast session for the MBS after sending the indication 834. In some aspects, the RAN may stop transmission of the content over the broadcast session following expiration of a timer after transmission of the indication 834. In some aspects, the RAN 802 may suspend the broadcast session of the MBS prior to sending the indication, and the indication may inform the UE 804 of the suspension.

As illustrated at 836, the UE 804 receives the downlink data for the MBS by multicast delivery and may continue to monitor MBS channels for resumption of the broadcast bearer for the MBS. For example, the UE 804 may associate the MBS session ID/TMGI of the service announcement received from the AS 814 for the broadcast of the corresponding MBS and may then receive the MBS content for the suspended broadcast session using a multicast mode procedure. For example, in FIG. 6, a UE 604 may stop receiving the broadcast signal 606 for the MBS and may start receiving the multicast signal 616 for the same MBS.

In some aspects, the UE 804 may detect the suspension of the corresponding broadcast bearer service for the MBS based on the indication 834, and may continue to monitor for an MBS broadcast mode delivery. In some aspects, the UE 804 may notify the GCS AS 814 of the broadcast service suspension, e.g., over an GCI interface or over a mission critical push to talk-1 (MCPTT-1) interface. The GCS AS may decide to set up the multicast delivery path for the downlink data for this service following the procedure described in connection with FIG. 7, for example. In some aspects, the GCS AS may inform the UE for the switch to the multicast delivery, e.g., multicast reception of the MBS at 836.

FIG. 9A illustrates a diagram 900 in which the UE 904 has an ongoing group communication using MBS multicast mode. The UE 904 may obtain the multicast information, at 920 from the AS 914. The UE 904 and the AS 914 may interact, such as described in connection with FIGS. 7 and/or 8, for the UE to obtain the multicast information and begin to receive the multicast session of the MBS. The AS 914, the UPF 908, the control plane (CP) 906, the MBSTF 912, and the NEF/MBSF 910 may communicate with each other for the MBS session creation.

At 922, the RAN 902 may decide to suspend one or more MBS bearer(s). The decision may include any of the aspects described in connection with the decision at 822 for the RAN 802 to suspend the multicast session for an MBS. The RAN may trigger the migration of impacted UEs to receive the downlink data in a unicast mode. As illustrated at 924, the RAN 802 may provide a suspension indication 924 to the impacted UE(s), e.g., 904. As part of providing the suspension indication 924, in some aspects, the RAN 802 may explicitly inform those UEs that the MBS bearer has been, or is going to be, suspended by broadcasting an indication and removing the TMGI for the corresponding multicast session for the MBS from the MCCH. The indication may be broadcast within a cell or broadcast area. The indication may be multicast in the cell or service area. The indication 924 may indicate to the UE 904 that an MTCH for the multicast session is going to be, or has been, suspended. In some aspects, the indication 924 may indicate to the UE to switch to a different cast type of the same MBS service. As an example, the indication 924 may indicate to the UE 904 to switch to a unicast session to continue to receive the same MBS content. In some aspects, the suspension indication 924 may be included in a MAC-CE indicating the multicast MRB suspension. In some aspects, the MAC-CE may be a dedicated MAC-CE for indicating the multicast MRB suspension. In some aspects, the suspension indication 924 may be received in a TMGI based group paging that indicates a suspension of the multicast in common signaling to the group of UEs receiving the multicast. In some aspects, the suspension indication 924 may be included in unicast signaling. As an example, the RAN 902 may remove a group radio network temporary identifier (G-RNTI) or a group configured scheduling radio network temporary identifier (G-CS-RNTI) associated with a particular TMGI for the corresponding multicast session in a unicast transmission to the UE 904. As an example, the unicast transmission may be unicast RRC signaling and/or a unicast MAC-CE to the UE 904. In some aspects, the indication 924 may be an implicit indication. In some aspects, the RAN 902 may remove the TMGI of the MBS bearer that has been suspended from the MCCH, which may indicate to the UE 904 that the multicast session is being suspended. As another example, the RAN 802 may remove the TMGI for the multicast session of the MBS from a SIB in order to indicate to the UEs receiving the multicast MBS that the multicast session has been, or will be suspended.

The RAN 902 may suspend the multicast session for the MBS. In some aspects, the RAN 902 may suspend the multicast session for the MBS after sending the indication 924. In some aspects, the RAN may stop transmission of the content over the multicast session following expiration of a timer after transmission of the indication 924. In some aspects, the RAN 902 may suspend the multicast session of the MBS prior to sending the indication, and the indication may inform the UE 904 of the suspension.

The UE may transition to unicast reception of the content for the MBS.

As an example, at 926, the UE may send a notification of a potential loss of an MBS bearer in a unicast message to the AS 914. The AS 914 may response with a unicast session set up 928 to enable the UE 904 to continue to receive the MBS content for the multicast session, e.g., for the same service, that is being suspended.

The UE 904 may receive the downlink data for the MBS by unicast delivery and may continue to monitor the MBS channels for resumption of the MBS bearer.

FIG. 9B is a diagram 950 illustrating that the UE 904 has an ongoing group communication using MBS broadcast mode. The UE 904 may obtain the broadcast information, at 930 from the AS 914. The UE 904 and the AS 914 may interact, such as described in connection with FIG. 7, for the UE to obtain the broadcast information and begin to receive the broadcast session of the MBS.

At 932, the RAN 902 may decide to suspend one or more broadcast bearers for the MBS. As an example, the RAN 902 may decide to suspend the broadcast bearers for the MBS bearer in response to an occurrence of a triggering condition. The triggering condition may be based on the number of UEs, congestion in the resources of the RAN, etc. For example, if the number of UEs or concentration of UEs in a particular area falls below a threshold amount, or location of the UEs is within an area that exceeds a threshold size, it may be better for the RAN to suspend the broadcast and instead unicast the MBS content. As an example, the RAN 902 may decide to suspend the broadcast bearers for the MBS after, or in response to, detecting MBS congestion that drops below a threshold congestion level. In some aspects, the decision, at 932, may be based on an allocation and retention policy (ARP) and/or on counting results for the corresponding MBS service(s)). The RAN may trigger the migration of impacted UEs to receive the downlink data in MBS uncast mode. As illustrated at 934, the RAN 902 may provide a suspension indication 934 to the impacted UEs, e.g., 904. As part of providing the suspension indication 934, in some aspects, the RAN 902 may explicitly inform those UEs that the broadcast bearer for the MBS has been, or is going to be, suspended by broadcasting an indication and removing the corresponding TMGI for the broadcast session of the MBS from the MCCH. The indication may be broadcast within a cell or broadcast area. The indication may be multicast in the cell or service area. The indication 934 may indicate to the UE 904 that an MTCH for the broadcast is going to be, or has been, suspended. In some aspects, the indication 934 may indicate to the UE to switch to a different cast type of the same service. As an example, the indication 934 may indicate to the UE 904 to switch to a unicast of the same MBS content. In some aspects, the suspension indication 934 may be included in a MAC-CE indicating the broadcast radio bearer suspension. In some aspects, the MAC-CE may be a dedicated MAC-CE for indicating the broadcast suspension. In some aspects, the suspension indication 934 may be received in a TMGI based group paging that indicates a suspension of the broadcast in common signaling to the group of UEs receiving the broadcast. In some aspects, the suspension indication 934 may be included in unicast signaling. As an example, the RAN 902 may remove a group radio network temporary identifier (G-RNTI) or a group configured scheduling radio network temporary identifier (G-CS-RNTI) associated with a particular TMGI in a unicast transmission to the UE 904. As an example, the unicast transmission may be unicast RRC signaling and/or a unicast MAC-CE to the UE 904. In some aspects, the indication 934 may be an implicit indication. In some aspects, the RAN 902 may remove the TMGI of the broadcast MBS bearer that has been suspended from the MCCH, which may indicate to the UE 904 that the broadcast session is being suspended. As another example, the RAN 902 may remove the TMGI for the broadcast session from a SIB in order to indicate to the UEs receiving the broadcast MBS that the broadcast session has been, or will be suspended.

The RAN 902 may suspend the broadcast session for the MBS. In some aspects, the RAN 902 may suspend the broadcast session for the MBS after sending the indication 934. In some aspects, the RAN may stop transmission of the content over the broadcast session following expiration of a timer after transmission of the indication 934. In some aspects, the RAN 802 may suspend the broadcast session of the MBS prior to sending the indication, and the indication may inform the UE 904 of the suspension.

The UE 904 receives the downlink data for the MBS by unicast delivery and may continue to monitor MBS channels for resumption of the broadcast bearer for the MBS. The UE may transition to unicast reception of the content for the MBS.

As an example, at 936, the UE may send a notification of a potential loss of an MBS bearer in a unicast message to the AS 914. The AS 914 may response with a unicast session set up 938 to enable the UE 904 to continue to receive the MBS content for the broadcast session, e.g., for the same service, that is being suspended.

The UE 904 may receive the downlink data for the broadcast session of the MBS by unicast delivery and may continue to monitor the MBS channels for resumption of the broadcast bearer.

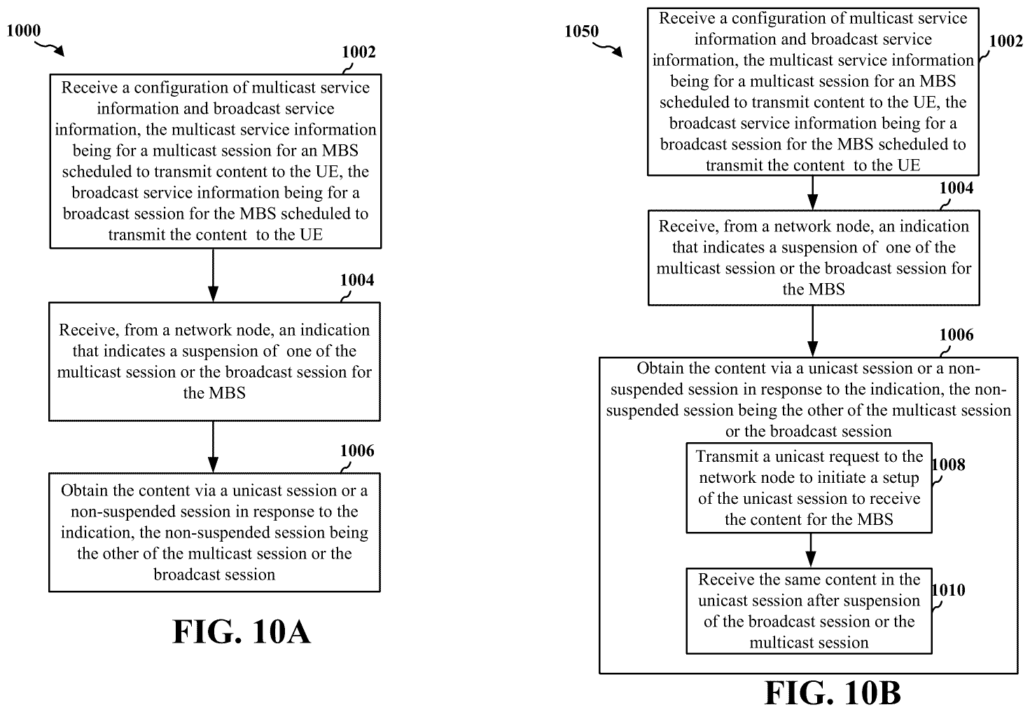

FIG. 10A is a flowchart 1000 of a method of wireless communication. The method may be performed by a UE (e.g., the UE 104, the UE 804, the UE 904; the apparatus 1104). The method may improve the efficient use of wireless resources for MBS while also providing the UE with continued service.

At 1002, the UE may receive a configuration of multicast service information and broadcast service information, the multicast service information being for a multicast session for an MBS scheduled to transmit content to the UE, the broadcast service information being for a broadcast session for the MBS scheduled to transmit the content to the UE. For example, the UE 804 or the UE 904 may receive (e.g., 820, 830, 920, or 930) a configuration of multicast service information or broadcast service information, the multicast service information being for a multicast session for an MBS scheduled to transmit content to the UE, the broadcast service information being for a broadcast session for the MBS. In some aspects, 1002 may be performed by the MBS switch component 198.

At 1004, the UE may receive, from a network node, an indication that indicates a suspension of one of the multicast session or the broadcast session for the MBS. For example, the UE 804 or the UE 904 may receive, from a network node (e.g., 802 or 902), an indication (e.g., 824, 834, 924, or 934) that one of the multicast session or the broadcast session for the MBS will be suspended. In some aspects, 1004 may be performed by the MBS switch component 198.

At 1006, the UE may obtain the content via a unicast session or a non-suspended session in response to the indication, the non-suspended session being the other of the multicast session or the broadcast session. For example, the UE 804 or the UE 904 may obtain the content via a unicast session or a non-suspended session of the multicast session or the broadcast session for the MBS in response to the indication. In some aspects, 1006 may be performed by the MBS switch component 198.

FIG. 10B is a flowchart 1050 of a method of wireless communication. The method may be performed by a UE (e.g., the UE 104, the UE 804, the UE 904; the apparatus 1104). The method may improve the efficient use of wireless resources for MBS while also providing the UE with continued service.

At 1002, the UE may receive a configuration of multicast service information and broadcast service information, the multicast service information being for a multicast session for an MBS scheduled to transmit content to the UE, the broadcast service information being for a broadcast session for the MBS scheduled to transmit the content to the UE. For example, the UE 804 or the UE 904 may receive (e.g., 820, 830, 920, or 930) a configuration of multicast service information or broadcast service information, the multicast service information being for a multicast session for an MBS scheduled to transmit content to the UE, the broadcast service information being for a broadcast session for the MBS. In some aspects, 1002 may be performed by the MBS switch component 198.

At 1004, the UE may receive, from a network node, an indication that indicates a suspension of one of the multicast session or the broadcast session for the MBS. For example, the UE 804 or the UE 904 may receive, from a network node (e.g., 802 or 902), an indication (e.g., 824, 834, 924, or 934) that one of the multicast session or the broadcast session for the MBS will be suspended. In some aspects, 1004 may be performed by the MBS switch component 198. In some aspects, the indication signals a transition between one of: the broadcast session for the MBS to the multicast session for the MBS, the multicast session for the MBS to the broadcast session for the MBS, the multicast session for the MBS to the unicast session for the MBS, or the broadcast session for the MBS to the unicast session for the MBS. In some aspects, the indication is received in a broadcast for a cell or a broadcast area. In some aspects, the indication is received in a multicast medium access control-control element (MAC-CE) indicating a multicast radio bearer (MRB) suspension. In some aspects, the indication is received in a group page that indicates a suspension of the multicast session.

At 1006, the UE may obtain the content via a unicast session or a non-suspended session in response to the indication, the non-suspended session being the other of the multicast session or the broadcast session. For example, the UE 804 or the UE 904 may obtain the content via a unicast session or a non-suspended session of the multicast session or the broadcast session for the MBS in response to the indication. In some aspects, 1006 may be performed by the MBS switch component 198. In some aspects, after a suspension of the multicast session or the broadcast session, the UE obtains the content via a session type indicated for the transition. In some aspects, the indication is included in a unicast radio resource control (RRC) message or a unicast medium access control-control element (MAC-CE) that removes a group radio network temporary identifier (G-CS-RNTI) or a group configured scheduling radio network temporary identifier (G-CS-RNTI) for a temporary mobile group identity (TMGI) for the multicast session or the broadcast session of the MBS. In some aspects, the indication is based on a removal of a temporary mobile group identity (TMGI) for the multicast session or the broadcast session of the MBS from a system information block (SIB) or multicast control channel (MCCH). In some aspects, the indication indicates that the multicast session for the MBS will be suspended, and the UE obtains the content via the broadcast session for the MBS in response to the indication. In some aspects, the indication indicates that the broadcast session for the MBS will be suspended, and the UE obtains the content via the multicast session for the MBS in response to the indication.

At 1008, the UE may transmit, in response to the indication, a unicast request to the network node to initiate a setup of the unicast session to receive the content. For example, the UE the UE 904 may transmit, in response to the indication, a unicast request (e.g., 926 or 936) to the network node to initiate a setup of the unicast session to receive the content. In some aspects, 1008 may be performed by the MBS switch component 198.

At 1010, the UE may receive the content in the unicast session after suspension of the broadcast session or the multicast session. For example, the UE 804 or the UE 904 may receive the content in the unicast session (e.g., 936 and 938) after suspension of the broadcast session or the multicast session. In some aspects, 1010 may be performed by the MBS switch component 198.

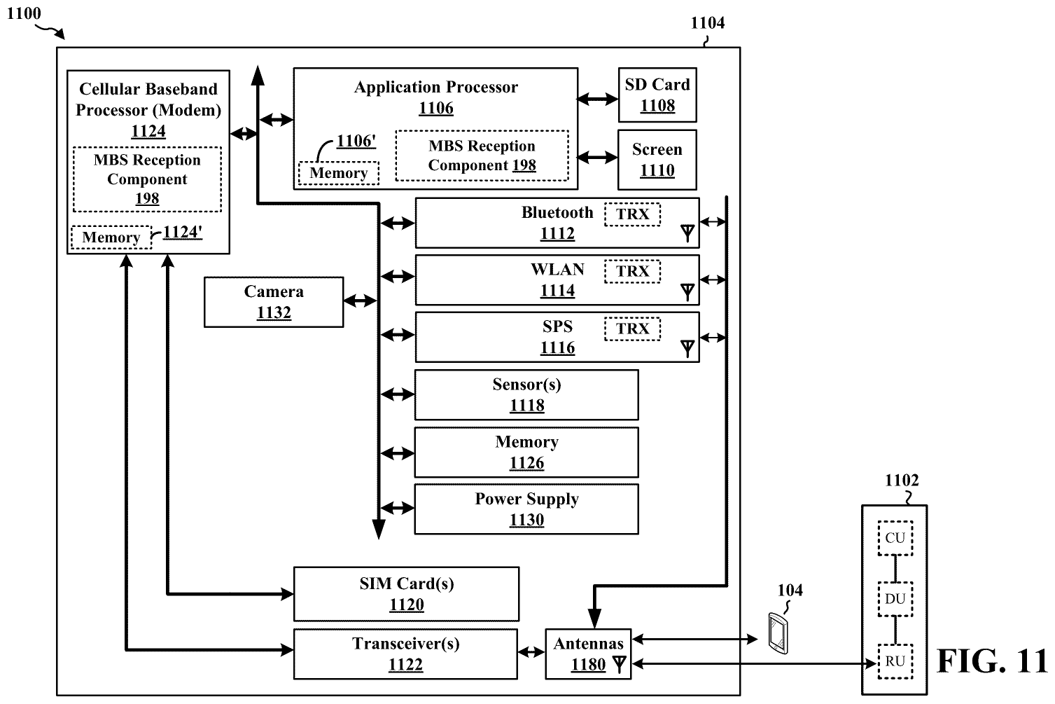

FIG. 11 is a diagram 1100 illustrating an example of a hardware implementation for an apparatus 1104. The apparatus 1104 may be a UE, a component of a UE, or may implement UE functionality. In some aspects, the apparatus1104 may include a cellular baseband processor 1124 (also referred to as a modem) coupled to one or more transceivers 1122 (e.g., cellular RF transceiver). The cellular baseband processor 1124 may include on-chip memory 1124′. In some aspects, the apparatus 1104 may further include one or more subscriber identity modules (SIM) cards 1120 and an application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor 1124 communicates through the transceiver(s) 1122 via one or more antennas 1180 with the UE 104 and/or with an RU associated with a network entity 1102. The cellular baseband processor 1124 and the application processor 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the UE 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see 350 of FIG. 3) and include the additional modules of the apparatus 1104.

As discussed supra, the MBS switch component 198 may be configured to receive a configuration of multicast service information or broadcast service information, the multicast service information being for a multicast session for a multicast broadcast service (MBS) scheduled to transmit content to the UE, the broadcast service information being for a broadcast session for the MBS. In some aspects, the MBS switch component 198 may be further configured to receive, from a network node, an indication that one of the multicast session or the broadcast session for the MBS will be suspended. In some aspects, the MBS switch component 198 may be further configured to obtain the content via a unicast session or a non-suspended session of the multicast session or the broadcast session for the MBS in response to the indication. The component 198 may be within the cellular baseband processor 1124, the application processor 1106, or both the cellular baseband processor 1124 and the application processor 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1104 may include a variety of components configured for various functions. In one configuration, the apparatus 1104, and in particular the cellular baseband processor 1124 and/or the application processor 1106, includes means for receiving a configuration of multicast service information or broadcast service information, the multicast service information being for a multicast session for a multicast broadcast service (MBS) scheduled to transmit content to the UE, the broadcast service information being for a broadcast session for the MBS. In some aspects, the apparatus 1104 may further include means for receiving, from a network node, an indication that one of the multicast session or the broadcast session for receiving content of the MBS will be suspended. In some aspects, the apparatus 1104 may further include means for obtaining content via a unicast session or a non-suspended session of the multicast session or the broadcast session for the MBS in response to the indication. In some aspects, the apparatus 1104 may further include means for transmitting, in response to the indication, a unicast request to the network node to initiate a setup of the unicast session to receive the content. In some aspects, the apparatus 1104 may further include means for receiving the content in the unicast session after suspension of the broadcast session or the multicast session. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

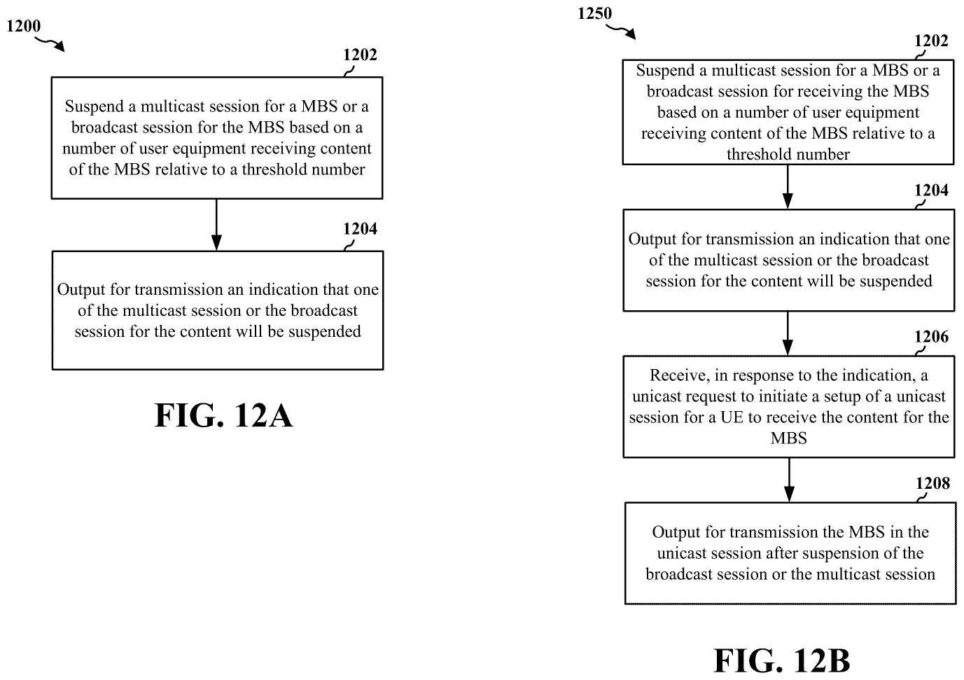

FIG. 12A is a flowchart 1200 of a method of wireless communication. The method may be performed by a network node (e.g., the base station 102, the RAN 802, the RAN 902, the network entity 1102, the network entity 1302). The method may improve the efficient use of wireless resources for MBS while also providing the UE with continued service. The method may enable a network to switch between multicast and broadcast sessions for an MBS, e.g., based on observed conditions in order to effectively provide the MBS while also reducing the use of radio resources.

At 1202, the network node may suspend one of a multicast session for an MBS or a broadcast session for the MBS based on a number of user equipment receiving content of the MBS relative to a threshold number. For example, the RAN 802 or the RAN 902 may suspend (e.g., at 822, 832, 922, or 932) a multicast session for an MBS or a broadcast session for the MBS based on a number of user equipment receiving content of the MBS relative to a threshold number. In some aspects, 1202 may be performed by the MBS reception component 199.

At 1204, the network node may output for transmission an indication that indicates a suspension of the one of the multicast session or the broadcast session for the content of the MBS. For example, the RAN 802 or the RAN 902 may output for transmission an indication (e.g., at 824, 834, 924, or 934) that one of the multicast session or the broadcast session for the content will be suspended. In some aspects, 1204 may be performed by the MBS reception component 199.

FIG. 12B is a flowchart 1250 of a method of wireless communication. The method may be performed by a network node (e.g., the base station 102, the RAN 802, the RAN 902, the network entity 1102, the network entity 1302). The method may improve the efficient use of wireless resources for MBS while also providing the UE with continued service. The method may enable a network to switch between multicast and broadcast sessions for an MBS, e.g., based on observed conditions in order to effectively provide the MBS while also reducing the use of radio resources.

At 1202, the network node may suspend one of a multicast session for an MBS or a broadcast session for the MBS based on a number of user equipment receiving content of the MBS relative to a threshold number. For example, the RAN 802 or the RAN 902 may suspend (e.g., at 822, 832, 922, or 932) a multicast session for an MBS or a broadcast session for the MBS based on a number of user equipment receiving content of the MBS relative to a threshold number. In some aspects, 1202 may be performed by the MBS reception component 199.

At 1204, the network node may output for transmission an indication that indicates a suspension of the one of the multicast session or the broadcast session for the content of the MBS. For example, the RAN 802 or the RAN 902 may output for transmission an indication (e.g., at 824, 834, 924, or 934) that one of the multicast session or the broadcast session for the content will be suspended. In some aspects, 1204 may be performed by the MBS reception component 199. In some aspects, the indication signals a transition between one of: the broadcast session for the MBS to the multicast session for the MBS, the multicast session for the MBS to the broadcast session for the MBS, the multicast session for the MBS to the unicast session for the MBS, or the broadcast session for the MBS to the unicast session for the MBS. In some aspects, the indication is included in a broadcast for a cell or a broadcast area. In some aspects, the indication is included in a multicast medium access control-control element (MAC-CE) indicating a multicast radio bearer (MRB) suspension. In some aspects, the indication is included in a group page that indicates a suspension of the multicast session. In some aspects, the indication is included in a unicast radio resource control (RRC) message or a unicast medium access control-control element (MAC-CE) that removes a group radio network temporary identifier (G-CS-RNTI) or a group configured scheduling radio network temporary identifier (G-CS-RNTI) for a temporary mobile group identity (TMGI) for the multicast session or the broadcast session of the MBS. In some aspects, the indication is based on a removal of a temporary mobile group identity (TMGI) for the multicast session or the broadcast session of the MBS from a system information block (SIB) or multicast control channel (MCCH). In some aspects, the indication indicates that the multicast session for the MBS will be suspended. In some aspects, the multicast session or the broadcast session is suspended after expiration of a timer following the indication.

At 1206, the network node may receive, in response to the indication, a unicast request to initiate a setup of a unicast session for a UE to receive content for the MBS. For example, the RAN 902 may receive, in response to the indication, a unicast request (e.g., 926 or 936) to initiate a setup of a unicast session for a UE to receive content for the MBS. In some aspects, 1206 may be performed by the MBS reception component 199.

At 1208, the network node may output for transmission the MBS in the unicast session after suspension of the broadcast session or the multicast session. For example, the RAN 802 or the RAN 902 may output for transmission the MBS in the unicast session (e.g., 928 or 938) after suspension of the broadcast session or the multicast session. In some aspects, 1208 may be performed by the MBS reception component 199.

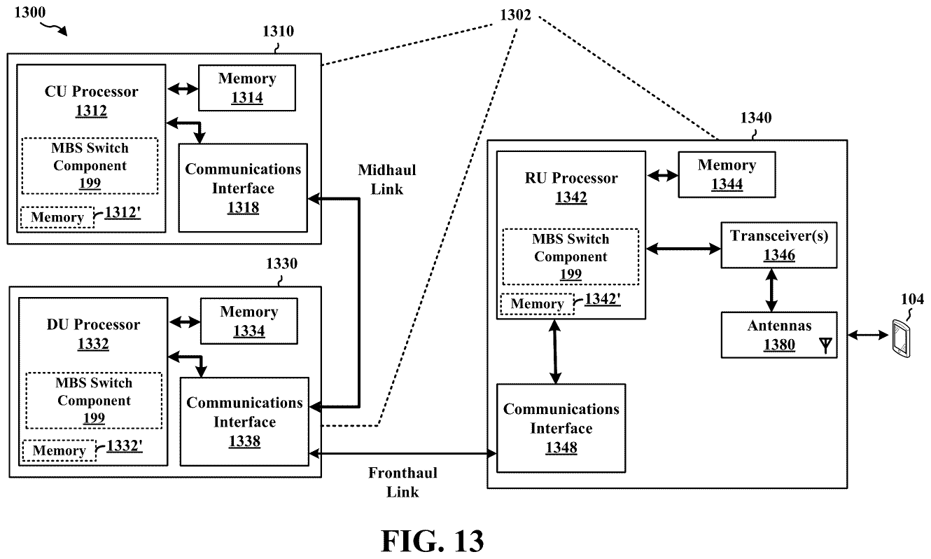

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include a CU processor 1312. The CU processor 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include a DU processor 1332. The DU processor 1332 may include on-chip memory 1332′. In some aspects, the DU 1330 may further include additional memory modules 1334 and a communications interface 1338. The DU 1330 communicates with the RU 1340 through a fronthaul link. The RU 1340 may include an RU processor 1342. The RU processor 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the MBS reception component 199 may be configured to suspend a multicast session for an MBS or a broadcast session for the MBS based on a number of user equipment receiving content of the MBS relative to a threshold number. In some aspects, the MBS reception component 199 may be further configured to output for transmission an indication that one of the multicast session or the broadcast session for the content will be suspended. The component 199 may be within one or more processors of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1302 may include a variety of components configured for various functions. In one configuration, the network entity 1302 includes means for suspending a multicast session for an MBS or a broadcast session for the MBS based on a number of user equipment receiving content of the MBS relative to a threshold number. In some aspects, the network entity 1302 may further include means for outputting for transmission an indication that one of the multicast session or the broadcast session for the content will be suspended. In some aspects, the network entity 1302 may further include means for receiving, in response to the indication, a unicast request to initiate a setup of a unicast session for a UE to receive the content. In some aspects, the network entity 1302 may further include means for outputting for transmission the content in the unicast session after suspension of the broadcast session or the multicast session. The means may be the component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: receive a configuration of multicast service information and broadcast service information, the multicast service information being for a multicast session for an MBS scheduled to transmit content to the UE, the broadcast service information being for a broadcast session for the MBS scheduled to transmit the content to the UE; receiving, from a network node an indication that indicates a suspension of one of the multicast session or the broadcast session for the MBS; and obtaining the content via a unicast session or a non-suspended session in response to the indication, the non-suspended session being the other of the multicast session or the broadcast session.

Aspect 2 is the method of aspect 1, where the indication signals a transition between one of: the broadcast session for the MBS to the multicast session for the MBS, the multicast session for the MBS to the broadcast session for the MBS, the multicast session for the MBS to the unicast session for the MBS, or the broadcast session for the MBS to the unicast session for the MBS.

Aspect 3 is the method of any of aspects 1-2, where, after a suspension of the multicast session or the broadcast session, the UE obtains the same content via a session type indicated for the transition.

Aspect 4 is the method of any of aspects 1-3, where the indication is received in a broadcast for a cell or a broadcast area.

Aspect 5 is the method of any of aspects 1-4, where the indication is received in a multicast MAC-CE indicating an MRB suspension.

Aspect 6 is the method of any of aspects 1-5, where the indication is received in a group page that indicates a suspension of the multicast session.

Aspect 7 is the method of any of aspects 1-6, where the indication is comprised in a unicast RRC message or a unicast-MAC-CE that removes a G-CS-RNTI or a G-CS-RNTI for a TMGI for the multicast session or the broadcast session of the MBS.

Aspect 8 is the method of any of aspects 1-7, where the indication is based on a removal of a TMGI for the multicast session or the broadcast session of the MBS from a SIB or MCCH.

Aspect 9 is the method of any of aspects 1-8, where the indication indicates that the multicast session for the MBS will be suspended, and the UE obtains the content via the broadcast session for the MBS in response to the indication.

Aspect 10 is the method of any of aspects 1-9, where the indication indicates that the broadcast session for the MBS will be suspended, and the UE obtains the content via the multicast session for the MBS in response to the indication.

Aspect 11 is the method of any of aspects 1-10, further comprising: transmitting, in response to the indication, a unicast request to the network node to initiate a setup of the unicast session to receive the content; and receiving the content in the unicast session after suspension of the broadcast session or the multicast session.

Aspect 12 is a method of wireless communication at a user equipment (UE), including: suspending one of a multicast session for a multicast broadcast service (MBS) or a broadcast session for the MBS based on a number of user equipment receiving content of the MBS relative to a threshold number; and outputting for transmission an indication that indicates a suspension of the one of the multicast session or the broadcast session for the content of the MBS.

Aspect 13 is the method of aspect 12, where the indication signals a transition between one of: the broadcast session for the MBS to the multicast session for the MBS, the multicast session for the MBS to the broadcast session for the MBS, the multicast session for the MBS to a unicast session for the MBS, or the broadcast session for the MBS to the unicast session for the MBS.

Aspect 14 is the method of any of aspects 12-13, where the indication is comprised in a broadcast for a cell or a broadcast area.

Aspect 15 is the method of any of aspects 12-14, where the indication is comprised in a multicast MAC-CE indicating an MRB suspension.

Aspect 16 is the method of any of aspects 12-15, where the indication is comprised in a group page that indicates a suspension of the multicast session.

Aspect 17 is the method of any of aspects 12-16, where the indication is comprised in a unicast RRC message or a unicast MAC-CE that removes a G-CS-RNTI or a G-CS-RNTI for a TMGI for the multicast session or the broadcast session of the MBS.

Aspect 18 is the method of any of aspects 12-17, where the indication is based on a removal of a TMGI for the multicast session or the broadcast session of the MBS from a SIB or MCCH.

Aspect 19 is the method of any of aspects 12-18, where the multicast session or the broadcast session is suspended after expiration of a timer following the indication.

Aspect 20 is the method of any of aspects 12-19, further comprising: receiving, in response to the indication, a unicast request to initiate a setup of a unicast session for a UE to receive the content; and outputting for transmission the content in the unicast session after suspension of the broadcast session or the multicast session.

Aspect 21 is an apparatus for wireless communication at a UE including a memory and at least one processor coupled to the memory and, based at least in part on information stored in the memory, configured to perform a method in accordance with any of aspects 1-11. The apparatus may include at least one of a transceiver or an antenna coupled to the at least one processor.

Aspect 22 is an apparatus for wireless communications, including means for performing a method in accordance with any of aspects 1-11.

Aspect 23 is a non-transitory computer-readable medium including instructions that, when executed by an apparatus, cause the apparatus to perform a method in accordance with any of aspects 1-11.

Aspect 24 is an apparatus for wireless communication at a UE including a memory and at least one processor coupled to the memory and, based at least in part on information stored in the memory, configured to perform a method in accordance with any of aspects 12-20. The apparatus may include at least one of a transceiver or an antenna coupled to the at least one processor.

Aspect 25 is an apparatus for wireless communications, including means for performing a method in accordance with any of aspects 12-20.

Aspect 26 is a non-transitory computer-readable medium including instructions that, when executed by an apparatus, cause the apparatus to perform a method in accordance with any of aspects 12-20.

What is claimed is:

1. An apparatus for wireless communication at a user equipment (UE), comprising:
a memory; and
at least one processor coupled to the memory and, based at least in part on information stored in the memory, the at least one processor is configured to:
receive a configuration of multicast service information and broadcast service information, the multicast service information being for a multicast session for a multicast broadcast service (MBS) scheduled to transmit content to the UE, the broadcast service information being for a broadcast session for the MBS scheduled to transmit the content to the UE;
receive, from a network node, an indication that indicates a suspension of one of the multicast session or the broadcast session for the MBS; and
obtain the content via a unicast session or a non-suspended session in response to the indication, the non-suspended session being the other of the multicast session or the broadcast session.

2. The apparatus of claim 1, wherein the indication signals a transition between one of:
the broadcast session for the MBS to the multicast session for the MBS,
the multicast session for the MBS to the broadcast session for the MBS,
the multicast session for the MBS to the unicast session for the MBS, or
the broadcast session for the MBS to the unicast session for the MBS.

3. The apparatus of claim 2, wherein, after the suspension of the multicast session or the broadcast session, the at least one processor is configured to obtain the content via a session type indicated for the transition.

4. The apparatus of claim 1, wherein the indication is received in a broadcast for a cell or a broadcast area.

5. The apparatus of claim 1, wherein the indication is received in a multicast medium access control-control element (MAC-CE) indicating a multicast radio bearer (MRB) suspension.

6. The apparatus of claim 1, wherein the indication is received in a group page that indicates the suspension of the multicast session.

7. The apparatus of claim 1, wherein the indication is comprised in a unicast radio resource control (RRC) message or a unicast medium access control-control element (MAC-CE) that removes a group radio network temporary identifier (G-RNTI) or a group configured scheduling radio network temporary identifier (G-CS-RNTI) for a temporary mobile group identity (TMGI) for the multicast session or the broadcast session of the MBS.

8. The apparatus of claim 1, wherein the indication is based on a removal of a temporary mobile group identity (TMGI) for the multicast session or the broadcast session of the MBS from a system information block (SIB) or multicast control channel (MCCH).

9. The apparatus of claim 1, wherein the indication indicates that the multicast session for the MBS will be suspended, and the at least one processor is configured to obtain the content via the broadcast session for the MBS in response to the indication.

10. The apparatus of claim 1, wherein the indication indicates that the broadcast session for the MBS will be suspended, and the at least one processor is configured to obtain the content via the multicast session for the MBS in response to the indication.

11. The apparatus of claim 1, wherein the at least one processor is configured to:
transmit, in response to the indication, a unicast request to the network node to initiate a setup of the unicast session to receive the content; and
receive the content in the unicast session after the suspension of the broadcast session or the multicast session.

12. The apparatus of claim 1, further comprising at least one of a transceiver or an antenna for receiving the indication.

13. An apparatus for wireless communication at a network node, comprising:
a memory; and
at least one processor coupled to the memory and, based at least in part on information stored in the memory, the at least one processor is configured to:
suspend one of a multicast session for a multicast broadcast service (MBS) or a broadcast session for the MBS based on a number of user equipment receiving content of the MBS relative to a threshold number; and
output for transmission an indication that indicates a suspension of the one of the multicast session or the broadcast session for the content of the MBS.

14. The apparatus of claim 13, wherein the indication signals a transition between one of:
the broadcast session for the MBS to the multicast session for the MBS,
the multicast session for the MBS to the broadcast session for the MBS,
the multicast session for the MBS to a unicast session for the MBS, or
the broadcast session for the MBS to the unicast session for the MBS.

15. The apparatus of claim 13, wherein the indication is comprised in a broadcast for a cell or a broadcast area.

16. The apparatus of claim 13, wherein the indication is comprised in a multicast medium access control-control element (MAC-CE) indicating a multicast radio bearer (MRB) suspension.

17. The apparatus of claim 13, wherein the indication is comprised in a group page that indicates the suspension of the multicast session.

18. The apparatus of claim 13, wherein the indication is comprised in a unicast radio resource control (RRC) message or a unicast medium access control-control element (MAC-CE) that removes a group radio network temporary identifier (G-RNTI) or a group configured scheduling radio network temporary identifier (G-CS-RNTI) for a temporary mobile group identity (TMGI) for the multicast session or the broadcast session of the MBS.

19. The apparatus of claim 13, wherein the indication is based on a removal of a temporary mobile group identity (TMGI) for the multicast session or the broadcast session of the MBS from a system information block (SIB) or multicast control channel (MCCH).

20. The apparatus of claim 19, wherein the multicast session or the broadcast session is suspended after expiration of a timer following the indication.

21. The apparatus of claim 13, wherein the at least one processor is configured to:
receive, in response to the indication, a unicast request to initiate a setup of a unicast session for a user equipment (UE) to receive the content; and
output for transmission the content in the unicast session after the suspension of the broadcast session or the multicast session.

22. The apparatus of claim 13, further comprising at least one of a transceiver or an antenna for transmitting the indication.

23. A method of wireless communication at a user equipment (UE), including:
receiving a configuration of multicast service information and broadcast service information, the multicast service information being for a multicast session for a multicast broadcast service (MBS) scheduled to transmit content to the UE, the broadcast service information being for a broadcast session for the MBS scheduled to transmit the content to the UE;
receiving, from a network node, an indication that indicates a suspension of one of the multicast session or the broadcast session for the MBS; and
obtaining the content via a unicast session or a non-suspended session in response to the indication, the non-suspended session being the other of the multicast session or the broadcast session.

24. The method of claim 23, wherein the indication signals a transition between one of:
the broadcast session for the MBS to the multicast session for the MBS,
the multicast session for the MBS to the broadcast session for the MBS,
the multicast session for the MBS to the unicast session for the MBS, or
the broadcast session for the MBS to the unicast session for the MBS.

25. The method of claim 24, wherein, after the suspension of the multicast session or the broadcast session, the UE obtains the content via a session type indicated for the transition.

26. The method of claim 23, wherein the indication is received in a broadcast for a cell or a broadcast area.

27. The method of claim 23, wherein the indication is received in a multicast medium access control-control element (MAC-CE) indicating a multicast radio bearer (MRB) suspension.

28. The method of claim 23, wherein the indication is received in a group page that indicates the suspension of the multicast session.

29. The method of claim 23, wherein the indication is comprised in a unicast radio resource control (RRC) message or a unicast medium access control-control element (MAC-CE) that removes a group radio network temporary identifier (G-RNTI) or a group configured scheduling radio network temporary identifier (G-CS-RNTI) for a temporary mobile group identity (TMGI) for the multicast session or the broadcast session of the MBS.

30. A method of wireless communication at a network node, including:
suspending one of a multicast session for a multicast broadcast service (MBS) or a broadcast session for the MBS based on a number of user equipment receiving content of the MBS relative to a threshold number; and
outputting for transmission an indication that indicates a suspension of the one of the multicast session or the broadcast session for the content of the MBS.
